(19) United States
(12) Patent Application Publication
(10) Pub. No.: US 2008/0220956 A1
(43) Pub. Date: Sep. 11, 2008

(54) Spreader Roll

(75) Inventor: Tuure Uusitalo, Tampere (FI)

Correspondence Address: BIRCH STEWART KOLASCH & BIRCH, PO BOX 747, FALLS CHURCH, VA, 22040-0747, US

(73) Assignee: PikoRolls Oy, Ylojarvi (FI)

(21) Appl. No.: 11/665,708

(22) PCT Filed: Oct. 25, 2005
(86) PCT No.: PCT/FI2005/000456

§ 371 Date: Nov. 19, 2007

(30) Foreign Application Priority Data
Oct. 25, 2004 (FI) 20041375

(51) Int. Cl. F16C 13/00

(52) U.S. Cl. 492/20

(57) ABSTRACT

A spreader roll comprising at least one actuator and a stationary and most advantageously curved spreader-roll axle (10) on which there are roll segments (6, 7 and 8) which roll segments are connected to each other with flexible connector members (11) in connection with shell sleeves (1) so that the roll-segment shell sleeves rotate bearing-mountedly around the spreader-roll axle, in which at least one roll segment (8) is an actuator which operates most advantageously as a drum motor rotating the roll-segment shell sleeves (1) around the spreader-roll axle.

This invention relates to a spreader roll used in the paper industry.

Nowadays, rotation machineries are used for rotating paper-machine spreader rolls which machineries are located outside the spreader rolls and from which forces are transmitted with belts, axles or other corresponding force-transmission mechanisms to the spreader roll.

Such spreader rolls are known in which the spreader roll is rotated by using an electric motor located outside the roll in the vicinity of the roll and from which the force rotating the spreader roll is transmitted to the spreader roll by means of belts or other corresponding force-transmission members. Such arrangements have disadvantages of great service need, the wear and tear of belts and the space requirement of the apparatus outside the spreader roll. Furthermore, the contamination of the electric motor and the belts may cause problems.

Additionally known solutions, such as publication FI-100350 B, present a spreader roll (spreader-roll drive connection) in which the electric motor rotating the spreader roll is connected directly to the end of the spreader roll outside the spreader-roll bracket and in which the connection is made by means of a separate connector and an extension axle. The electric motor requires space outside the spreader roll, and the structure is also relatively complex and susceptible to failure because of the required extension axle and connector and other required structural parts.

The purpose of this invention is to achieve a novel kind of a rotation-motor solution rotating a spreader roll in which the rotation motor, which is a drum motor, is arranged as part of the spreader roll so that the rotation motor is integrated to one roll segment which roll segment is the outermost roll segment of the other end of the spreader roll. Roll segments are connected to each other with flexible connector members, and the roll segments may be disconnected from each other.

In the drum motor, stator winding is arranged in such a way that the winding is on a stationary axle, and the rotor is located inside the spreader-roll shell (=shell sleeve/end sleeve). Cables feeding the motor are arranged to pass through an opening located in the head of the spreader roll or they can also pass inside the axle.

By arranging the electric motor rotating the spreader roll as part of the spreader roll, considerable advantages may be accomplished compared to known and already used solutions.

Compared to currently known solutions, an advantage of the solution according to the invention is that no space is required outside the spreader roll for the electric motor and force-transmission devices, such as belts or axles, as the electric motor is arranged as part of one roll segment. Also, no belt wearing and breakdowns occur like in belt-driven rolls, and a further advantage is also that the electric motor and other force-transmitting parts are not as susceptible to contamination as they are protected inside the spreader-roll structure.

When a failure of the electric motor occurs, a roll segment comprising an electric motor may be disconnected from the next roll segment and replaced by another roll segment comprising an electric motor, whereby downtimes in the operation of the spreader roll remain quite short in the occurrence of an electronic motor failure.

Also the rotation speed of the spreader roll may be controlled precisely as the control of the drum-motor rotation speed occurs most usually, inter alia, by means of an inverter, and additionally no failures caused by outside belts or corresponding force-transmission members etc. occur.

In the solution according to the invention, spreader rolls (spreader-roll segments) may be coated or uncoated.

Furthermore, the invention is characterised by what is stated in the appended claims and especially by what is stated in the characterising part of claim 1.

Next, the invention is described in more detail by referring to the accompanying drawings in which

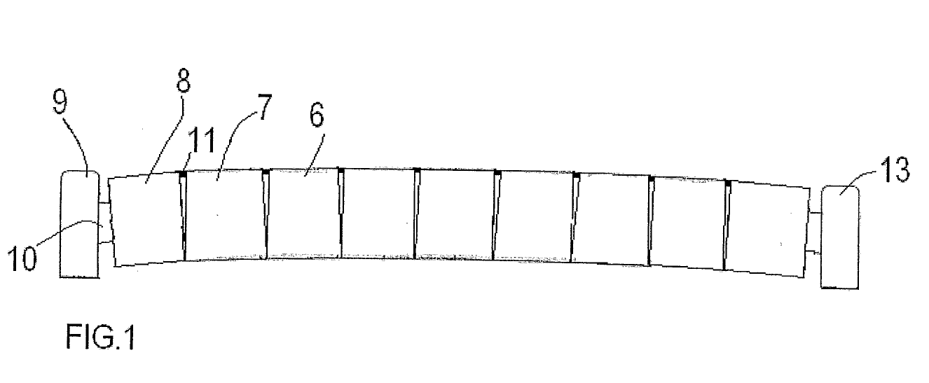

FIG. 1 presents a front view of a spreader roll.

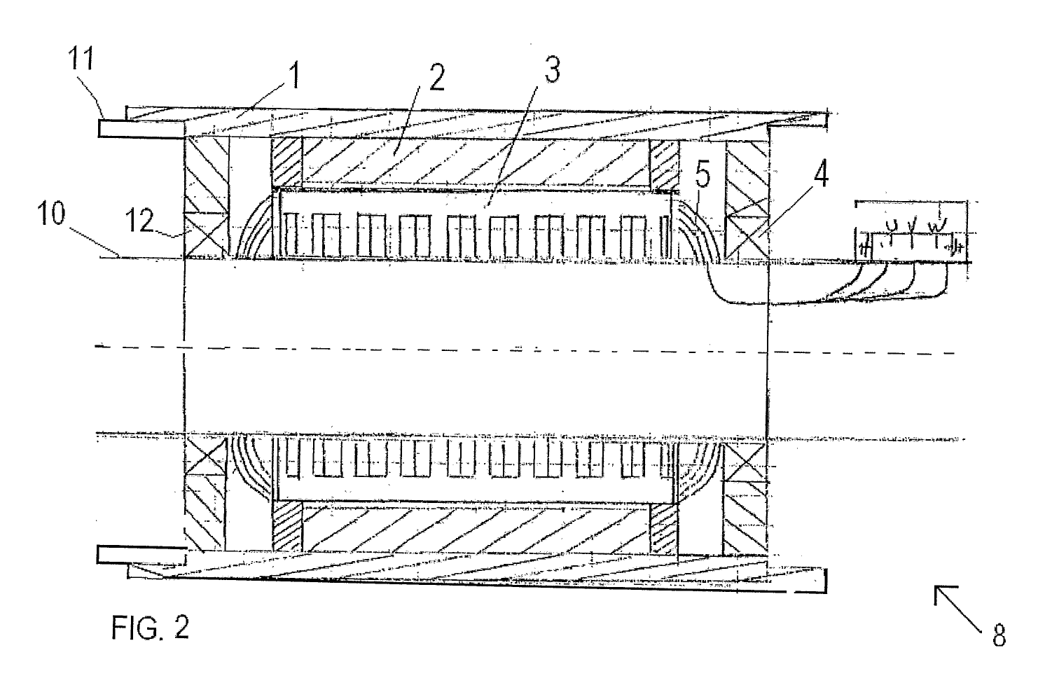

FIG. 2 is a cross-section of a roll segment comprising a spreader-roll drum motor.

According to what is presented in FIGS. 1 and 2, a spreader roll comprises at least one actuator and a stationary and most advantageously curved spreader-roll axle 10 on which there are roll segments 6,7 and 8 which roll segments are connected to each other with flexible connector members 11 in connection with shell sleeves 1 so that the roll-segment shell sleeves rotate bearing-mountedly around the spreader-roll axle, and at least one roll segment 8 is an actuator which operates most advantageously as a drum motor rotating the roll-segment shell sleeves 1 around the spreader-roll axle.

When the roll segments 7, 8 etc. are connected to each other with a flexible connector member 11 connected to each roll segment, the flexible connector member transmits forces from each roll segment to the next roll segment thus enabling the rotation of all roll-segment shell sleeves 1. Being flexible, the roll-segment connector members enable the curving of the top surface of the spreader roll on a preliminary bent axle.

The roll segment 8 operating as the drum motor is installed so that it is the outermost roll segment, or if two roll segments operate as the drum motor, they are the outermost roll segments. The roll segment operating as the actuator may also be installed so that it is any roll segment between the outermost roll segments (one or several).

The connector member 11 for connecting roll segments to each other may be disconnected from each roll segment, and if necessary, individual roll segments may be removed or added on the spreader-roll axle.

The spreader-roll axle 10 is bearing-mounted to supports 9, 13.

The roll segment 8 of the spreader roll operating as the drum motor comprises a stator 3 installed on the spreader-roll axle and a rotor 2 fastened inside the shell sleeve 1. Current is led to the stator 3 windings with feeders 5 which pass inside the spreader-roll axle 10, or which pass from an opening in the head of the roll segment. The shell sleeve 1 is bearing-mounted with bearings 4 or corresponding on the spreader-roll axle 10 so that the shell sleeve 1 is able to rotate around the spreader-roll axle. The roll segment operating as the drum motor is fastened with a flexible fastening member 11 to the next roll segment. A simplified fastening member is presented in FIGS. 1 and 2.

It is well known by those skilled in the art that the invention is not limited to the embodiments described above, but it may vary within the scope of the enclosed patent claims.

According to the inventive idea, used solutions may be varied quite widely. One may contemplate, for example, such a solution in which, instead of individual connector members, the roll has a one-piece rubber shell which connects the rolls to each other like a connector member.

1. A spreader roll comprising at least one actuator and a stationary and most advantageously curved spreader-roll axle (10) on which there are roll segments (6, 7 and 8) which roll segments are connected to each other with flexible connector members (11) in connection with shell sleeves (1) so that the roll-segment shell sleeves rotate bearing-mountedly around the spreader-roll axle, characterised in that at least one roll segment (8) is an actuator which operates most advantageously as a drum motor rotating the roll-segment shell sleeves (1) around the spreader-roll axle.

2. A spreader roll according to claim 1, characterised in that the roll segment (8) operating as the actuator is installed so that it is the outermost roll segment.

3. A spreader roll according to claim 1, characterised in that the roll segments operating as the actuator are installed so that they are the outermost roll segments.

4. A spreader roll according to claim 1, characterised in that the roll segment operating as the actuator is installed so that it is any roll segment between the outermost roll segments.

5. A spreader roll according to claim 1, characterised in that a connector member (11) for connecting roll segments to each other may be disconnected from each roll segment, and individual roll segments may be removed or added on the axle.

6. A spreader roll according to claim 1, characterised in that the spreader-roll drum motor comprises a stator (3) installed on the spreader-roll axle, and a rotor (2) which is fastened inside the shell sleeve (1), and that current is led to the stator (3) windings with feeders (5) which pass inside the spreader-roll axle (10) or which pass from the opening in the head of the roll segment.
